(19) United States
(12) Patent Application Publication
(10) Pub. No.: US 2007/0138785 A1
(43) Pub. Date: Jun. 21, 2007

(54) Album assembly

(76) Inventor: Helen Avraamides, Florida Hills (ZA)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 10/584,250

(22) PCT Filed: Dec. 23, 2004
(86) PCT No.: PCT/IB04/04261

§ 371 Date: Jan. 9, 2007

(30) Foreign Application Priority Data
Dec. 25, 2003 (ZA) 2003/4943

(51) Int. Cl. B42D 1/00

(52) U.S. Cl. 281/21.1

(57) ABSTRACT

The invention relates to a file assembly (100) for keeping personal records. The assembly (100) includes a binder (16), and at least one sleeve (102) and at least one photograph display device (104) received in the binder (16). Each sleeve (102) has opposed operatively front and rear walls (22, 24). The front wall (22) is smaller than the rear wall (24) and has a periphery along part of which it is secured to the rear wall (24), such that the walls (22, 24) define between them a pocket (38), having a peripheral opening (40), for receipt of personal records. Each photograph display device (104) is for displaying at least one photograph. The binder (16) is provided with a securing mechanism (17) by means of which each sleeve (102) and each photograph display device (104) are removably secured in place in the binder (16).

THIS INVENTION relates to an album assembly. It more particularly relates to an album assembly for keeping personal records such as pictures, photographs, certificates, general or ceremonial documents, and the like.

In accordance with the invention there is provided a file assembly for keeping personal records, the assembly including, in combination:

at least one sleeve having opposed operatively front and rear walls, the front wall being smaller than the rear wall, and the front wall having a periphery along part of which it is secured to the rear wall, such that the walls define between them a pocket, having a peripheral opening, for receipt of personal records;

at least one photograph display device for displaying at least one photograph; and

a binder within which each sleeve and each photograph display device are received, the binder having a securing mechanism for releasably securing each sleeve and each photograph display device in place therein.

The binder may include a planar rectangular front cover, a planar rectangular rear cover, and a spine interconnecting the front cover and the rear cover and about which spine the binder is foldable book-fashion, the securing mechanism being located between the covers of the binder, each sleeve and each photograph display device being secured between the covers of the binder. The front cover, the rear cover and the spine of the binder may be of board-like construction, the spine being rectangular and adjacent edges of the spine and of each of the covers defining a pair of fold lines about which the binder is foldable. By board-like is meant that the covers and spine have a stiffness or rigidity of the nature of that of cardboard, so that they can support themselves and the sleeves and display devices without sagging under gravity. In a particular embodiment, the front cover, the rear cover and the spine of the binder may be integrally formed, the binder being provided with two laterally spaced substantially parallel grooves extending over at least one face of the binder and defining the spine therebetween, the grooves providing said fold lines about which the binder is foldable.

The securing mechanism may comprise a row of clasps fast with the rear cover adjacent the spine or fast with the spine and spaced in series from each or one another, each sleeve and each photograph display device being provided with a corresponding plurality of openings adjacent edges thereof extending alongside the spine, through which openings the clasps are received.

Each sleeve may be rectangular in outline, the front wall of the sleeve being spaced outwardly from the edge of the rear wall extending alongside the spine, the openings through the sleeve extending only through the rear wall of the sleeve, and areas of the rear wall surrounding said openings being reinforced to inhibit initiation or propagation of cracks or tears in the rear wall. Each sleeve may be of unitary construction, being formed from a single sheet of cardboard which is folded over on to itself to define the front wall and the rear wall, side edges of the front wall being folded towards each other to define flaps by means of which the side edges of the front wall are secured to the rear wall.

Each photograph display device may include a rectangular transparent photograph-receiving pocket for receiving photographs or for receiving a sheet on which photographs are mounted.

Each photograph display device and the rear wall of each sleeve may be essentially the same shape and size when seen face-on, each photograph display device and the rear wall of each sleeve being smaller in outline than the front cover and the rear cover of the binder, such that the front and the rear covers of the binder at free edges thereof overhang each sleeve and overhang each photograph display device received therebetween.

The assembly may include a plurality of sleeves and a plurality of photograph display devices interleaved between the sleeves to alternate therewith, an operatively rear face of the rear wall of each sleeve providing writing space for receiving written information associated with records kept in the pocket of the sleeve. Naturally, if desired, an operatively front face of the front wall of each sleeve may also provide designated writing space for receiving written information associated with personal records kept in the pocket of the sleeve.

The assembly may further include a protective cover within which the binder is received for protecting it, the cover being in the form of a box-shaped sheath.

In accordance with another aspect of the invention there is provided a sleeve for receiving personal records, the sleeve being a sleeve as hereinbefore described with reference to the album assembly.

The invention is now described, by way of example, with reference to the accompanying diagrammatic drawings.

In the drawings:

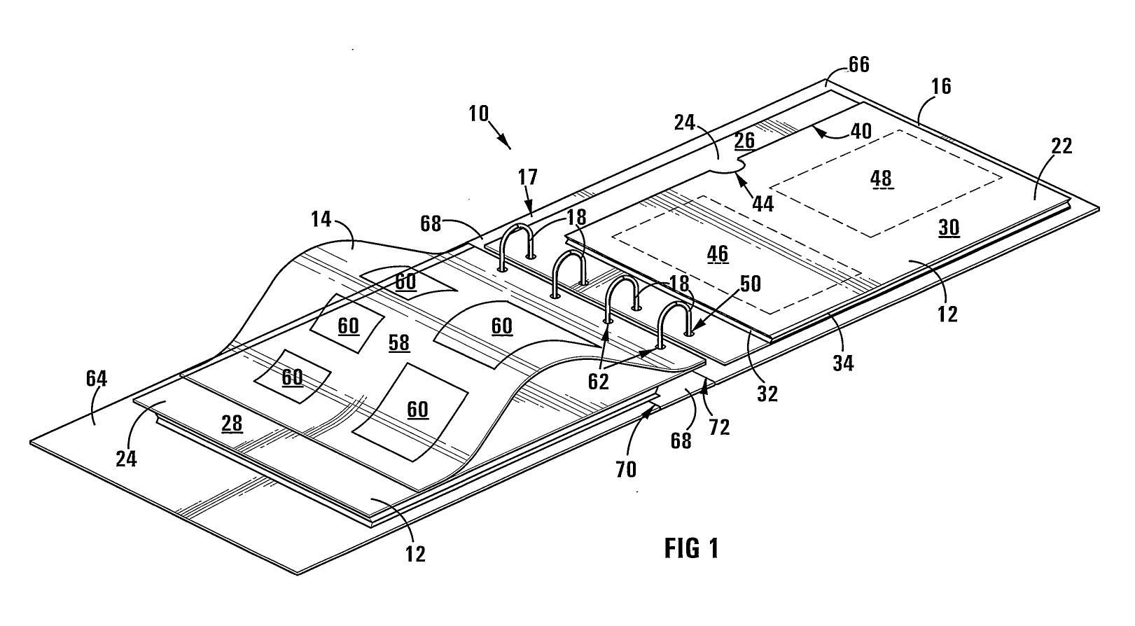

FIG. 1 shows, in three-dimensional view, part of one embodiment of an album assembly in accordance with the invention;

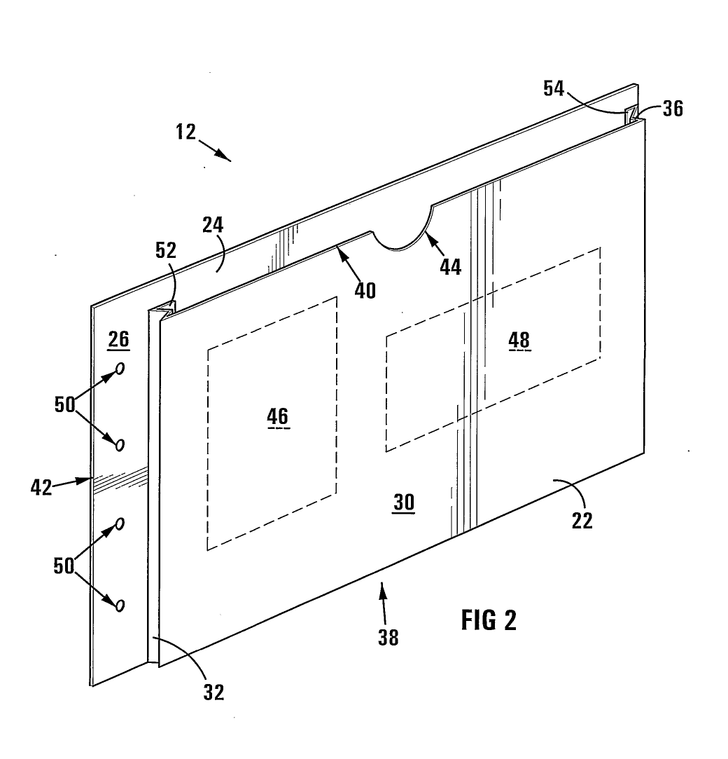

FIG. 2 shows, in three-dimensional view, a sleeve forming part of the album assembly shown in FIG. 1;

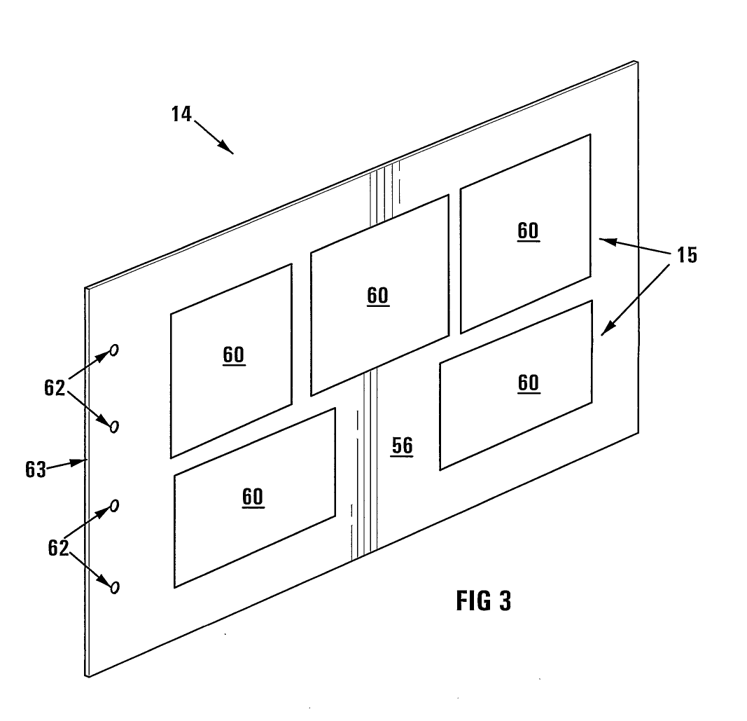

FIG. 3 shows, in three-dimensional view, a photograph display device forming part of the album assembly shown in FIG. 1;

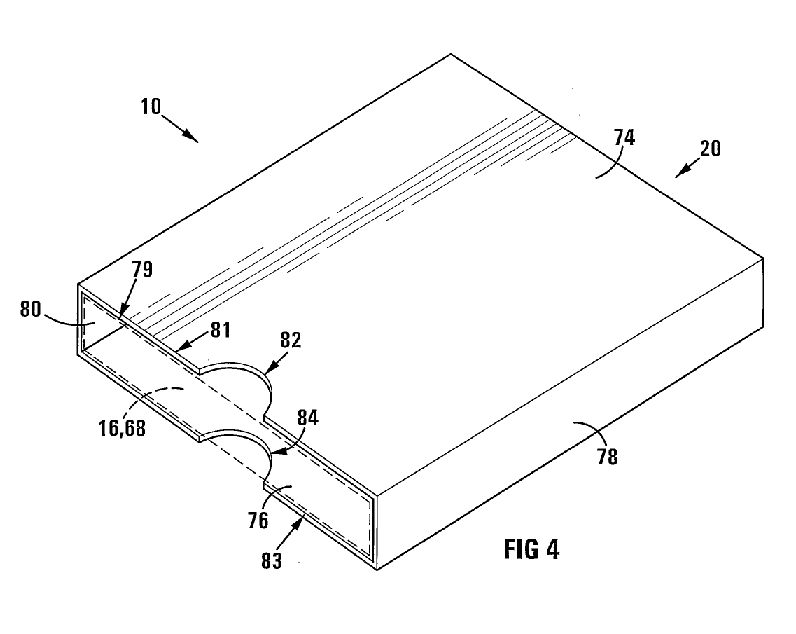

FIG. 4 shows, in three-dimensional view, a protective cover forming part of an album assembly in accordance with the invention, with a binder also forming part of the album assembly in accordance with the invention received therein, the binder being shown in broken lines;

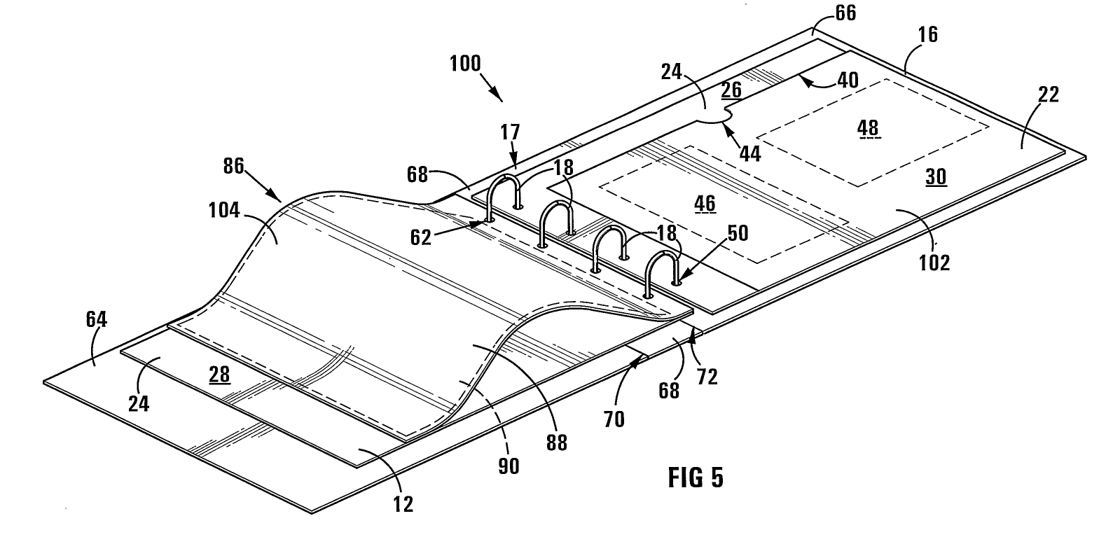

FIG. 5 shows, in three-dimensional view, part of another embodiment of an album assembly in accordance with the invention;

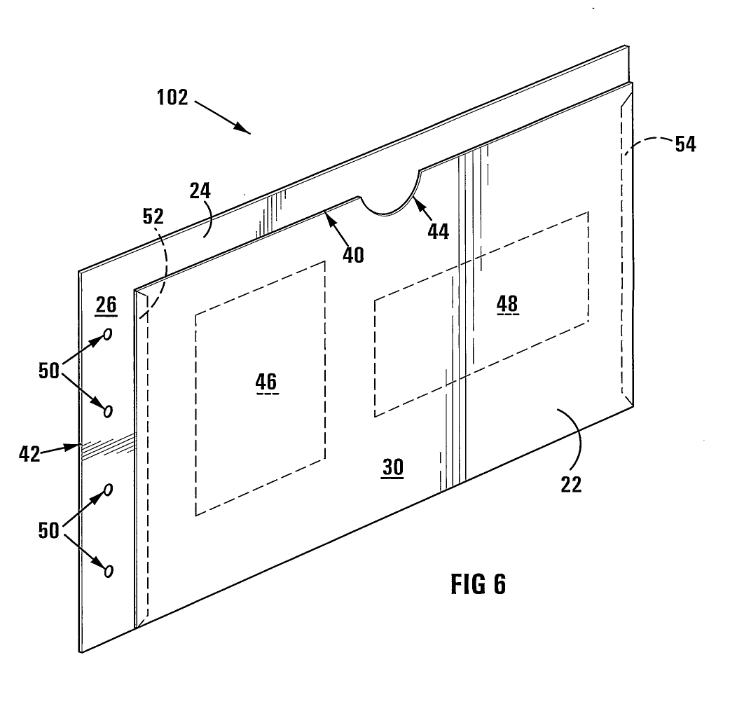

FIG. 6 shows, in three-dimensional view, a sleeve forming part of the album assembly shown in FIG. 5; and

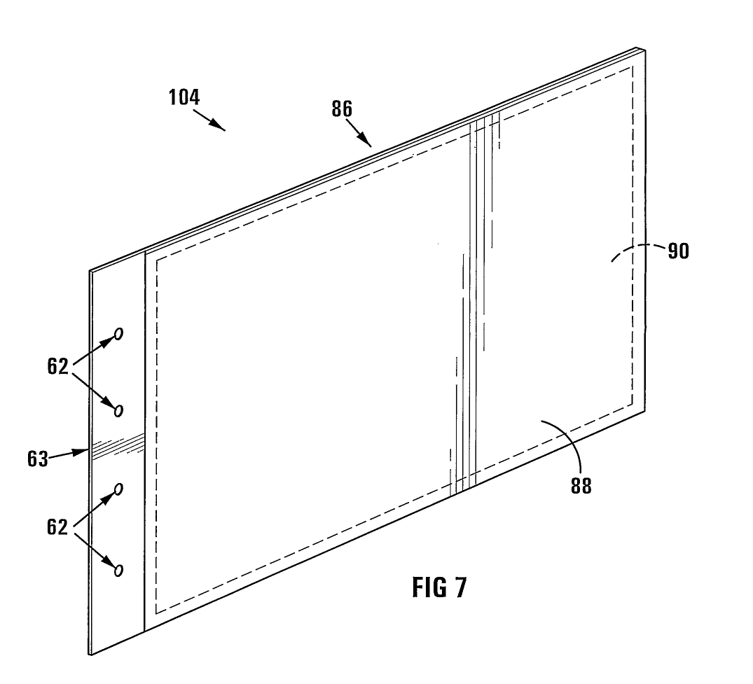

FIG. 7 shows, in three-dimensional view, a photograph display device forming part of the album assembly shown in FIG. 5.

With reference to FIG. 1 of the drawings, part of one embodiment of an album assembly in accordance with the invention is generally indicated by reference numeral 10. For ease of reference that part of the album assembly shown in FIG. 1 is also hereinafter referred to as the album assembly 10.

The album assembly 10 includes seventeen sleeves 12, only two of which is shown in FIG. 1, (see also FIG. 2) for receiving personal records such as pictures, photographs, certificates, general or ceremonial documents, and the like. The album assembly 10 includes also sixteen photograph display devices 14, only one of which is shown in FIG. 1, (see also FIG. 3) for displaying photographs (not shown). The display devices 14, in the embodiment shown in FIG. 1, are in the in the form of transparent sheets providing mounting formations generally indicated by reference numeral 15 for mounting photographs thereon.

The album assembly 10 further includes a binder 16 (shown in broken lines in FIG. 4) in which the sleeves 12 and the photograph display devices 14 are received, the photograph display devices 14, in this embodiment, being interleaved between the sleeves 12, such that they alternate with the sleeves 12. The binder 16 has a securing mechanism, generally indicated by reference numeral 17, in the form of a row or series of hoops or clasps 18 for releasably and removably securing the sleeves 12 and the photograph display devices 14 in place in the binder 16. In this embodiment, although not visible, the hoops or clasps 18 are secured together by means of an elongated base (not shown).

The album assembly 10 yet further includes a protective cover 20 (FIG. 4) in the form of a box-shaped sheath of relatively sturdy scratch- or scuff-resistant construction.

Referring now also in particular to FIG. 2, each sleeve 12 has opposed operatively front and rear walls, respectively being indicated by reference numerals 22 and 24, each of which provides an operatively front and an operatively rear major face. The front and rear major faces of the rear wall 24 are respectively indicated by reference numerals 26 and 28, the front major face of the front wall 22 being indicated by reference numeral 30. The front wall 22 and the rear wall 24 are both rectangular in outline, being secured together adjacent their peripheries by means of peripheral walls in the form of side walls 32 and 36 and by a bottom wall 34 (FIG. 1), to define a pocket 38 having a peripheral opening 40 at its top. The personal records are thus received within the pocket 38. Each of the peripheral walls 32, 34, 36 is folded so that the pocket 38 is expansible and collapsible concertina-fashion, for permitting reversible expansion of the pocket 38 in accordance with the number or thickness of records received therein.

The rear wall 24 of the sleeve 12 is in the form of a planar rectangular sheet of relatively sturdy acid-free cardboard. The front wall 22 of the sleeve 12 is of a similar construction and, in this embodiment, the folded peripheral walls 32, 34, 36 are integrally formed with the front wall 22. The front wall 22 is spaced operatively radially outwardly from an operatively radially inner edge 42 of the rear wall 24, and is secured to the rear wall 24 by means of flaps 52, 54 fast with the side walls 32, 36, and a flap (not visible) fast with the bottom wall 34. The flaps 52, 54 and the flap which is not visible are thus extensions of the peripheral walls 32, 36, 34.

The front wall 22 has a semi-circular indentation or cut-out 44 in an operatively top edge thereof, to facilitate removal of records received in the pocket 38, from the pocket 38. The front face 30 of the front wall 22, provides mounting space for mounting pictures or photographs 46, 48 (shown in broken lines) thereon. In this embodiment, the photographs 46, 48 are adhesively mounted to the front face 30. In some embodiments, not shown, the front face 30 may provide mounting formations for mounting the photographs 46, 48. Furthermore, the front face 30 provides a designated writing space (not shown) for receiving written information associated with personal records kept in the pocket 38 of the sleeve 12.

The sleeve 12 further includes, spaced slightly radially operatively outwardly from the inner edge 42 of the rear wall 24, four spaced and aligned openings 50, for receiving the clasps 18 when the sleeve 12 is received within the binder 16. Although not shown as such, areas of the rear wall 24 surrounding the openings 50 are reinforced to inhibit initiation or propagation of cracks or tears in these areas of the rear walls 24.

The sleeves 12 can, if desired, be of different colours or be provided with different decorative surface patterns. Likewise, some of the sleeves 12 may, if desired, be of like colour or be provided with like patterns.

Referring now in particular to FIG. 3, the photograph display device 14 is rectangular, and of a size substantially equal to that of the sleeve 12. The device 14 provides opposed operatively front and rear faces, the front face only being visible and being indicated by reference numeral 56. The mounting formations 15 are in the form of transparent pockets 60 provided on both the front face 56 and the rear face of the device 14. In this embodiment, each face of the device 14 is provided with five pockets 60. Naturally, each of these faces can be provided with any other desired number of pockets 60. The pockets 60 are secured at their peripheries to the front face 56 and to the rear face of the device 14 and provide peripheral openings (not visible) via which pictures or photographs can be inserted into the pockets 60.

The device 14 further includes four openings 62 arranged on the device 14 in similar fashion to the openings 50 on the sleeve 12, likewise for receiving the clasps 18 when the devices 14 are received within the binder 16. Here also, areas of the devices 14 surrounding the openings 62 are reinforced to inhibit initiation or propagation of cracks or tears in these areas of the devices 14.

With particular reference now to FIG. 1, the binder 16 includes a rectangular front cover 64 and a rectangular rear cover 66, the covers 64, 66 being of the same size and shape and interconnected by a rectangular spine 68. The elongated base whereby the hoops or clasps 18 are connected together is fast with the spine 68. The front cover 64, the rear cover 66 and the spine 68 are all in the form of relatively thick cardboard sheets. The spine 68 is defined between the front cover 64 and the rear cover 66 by means of fold lines 70, 72 extending along operatively radially inner edges of the front cover 64 and of the rear cover 66. In some embodiments (not shown), the front cover 64, the rear cover 66, and the spine 68 are of separate cardboard sheets connected together along the respective fold lines 70, 72. In this embodiment, however, the front cover 64, the rear cover 66, and the spine 68 are of unitary construction, the fold lines 70, 72 being provided by grooves extending along side edges of the spine 68. Naturally, the covers 64, 66 and spine 68 can instead be of polyvinyl chloride (PVC) or any other suitable plastics material. Although not visible in the drawings, the binder 16 is partially covered with a water-repellent synthetic plastics protective layer.

Referring now to FIG. 4 of the drawings, the protective cover 20 includes rectangular opposed major walls 74, 76 connected together by means of rectangular side walls 78, 80 and a rectangular rear wall which is not visible, and provides a rectangular mouth opening 79. The major faces 74, 76 are provided, at their edges 81, 83 defining the mouth opening 79, with semi-circular recesses 82, 84 for facilitating removal of the binder 16 (shown in broken lines in FIG. 4) from the protective cover 20. Naturally, in other embodiments (not shown) of the protective cover 20, said semi-circular recesses 82 can be omitted. Furthermore, although not visible in the drawings, an exposed outer part of the cover 20 is covered with a protective water-repellent layer.

Referring now to FIG. 5 of the drawings, part of another embodiment of an album assembly in accordance with the invention is generally indicated by reference numeral 100. The assembly 100 serves the same purpose as the assembly 10 of FIG. 1 and, accordingly, unless otherwise indicated, reference numerals used to indicate parts or features of the assembly 10 are also used to indicate like parts or features of the assembly 100.

The binder 16 of the assembly 100, with the exception that the securing mechanism 17 of the assembly 100 is fast with the rear cover 66, is exactly the same as the binder 16 of the assembly 10 and, accordingly, it is not again described.

FIG. 6 of the drawings shows a sleeve forming part of the assembly 100. The embodiment of the sleeve shown in FIG. 5 is generally indicated by reference numeral 102. The sleeve 102 is of unitary cardboard construction and includes a front wall 22 and a rear wall 24. In this embodiment, however, the sleeve 102 does not include the side walls 32, 36 and the bottom wall 34, such that the pocket 38 of the sleeve 102 is not extensible and collapsible in concertina-fashion like the pocket 38 of the sleeve 12 of FIG. 2. Sides of the front wall 22 are folded towards each other to define the flaps 52, 54 by means of which side edges of the front wall 22 are secured to the rear wall 24. The reinforcement of the areas surrounding the openings 50 provided in the rear wall 24 of the sleeve 102 is by means of a synthetic plastics strip (not visible) provided on the rear face 28 of the rear wall 24. Said strip is adhesively secured to and extends along the operatively radially inner edge 42 of the rear wall 24. Naturally, said synthetic plastics strip is also provided with four openings respectively aligned with the openings 50. With the exception of the aforementioned differences, the sleeve 102 of the assembly 100 is substantially similar to the sleeve 12 of the assembly 10 and, accordingly, the sleeve 102 is not described in any further detail.

FIG. 7 shows a photograph display device forming part of the assembly 100. The photograph display device is generally indicated by reference 104 and provides a transparent open-topped pocket 86. Naturally, the album assembly 10 or 100, as the case may be, may include both the devices 14 and the devices 104.

The device 104 is rectangular, and of a size substantially equal to those of the sleeve 12, 102 and of the device 14. The device 104 provides said open-topped pocket 86 defined between two transparent sheets, only a front one of which is visible and is indicated by reference numeral 88, within which photographs (not shown) are receivable. The transparent sheet 88 and the other transparent sheet are secured together along their peripheries to define the open-topped pocket 86. The device 104 further includes four openings 62 arranged on the device 104 in similar fashion to the openings 62, of the device 14, likewise for receiving the clasps 18 when the devices 104 are received within the binder 16.

In the embodiment of the device 104 shown in FIG. 7, photographs (not shown) received within the pocket 86 are mounted on an opaque sheet, in this embodiment a flexible acid-free cardboard sheet 90 (shown in broken lines), with the cardboard sheet 90, in turn, being received within the pocket 86. When a plurality of devices 104 are received within the binder 16, the various cardboard sheets 90 may be of different colours, or may be provided with different patterns. Likewise, some of the cardboard sheets 90 may be of like colour, or be provided with the same patterns.

As can be seen in FIGS. 1 and 5, the devices 14, 104 are, as mentioned, interleaved between the sleeves 12, 102. The operatively rear faces 28 of the rear walls 24 of the sleeves 12, 102 provide writing space for receiving information associated with personal records received in the pocket 38 of the sleeve 12, 102 or in a neighboring sleeve 12, 102 and associated with pictures received in the pockets 60, 86 of a neighboring device 14, 104. Thus, in some embodiments, in use, when the binder 16 is laid flat (as shown in FIGS. 1 and 5), information received on the rear face 28 of one sleeve 12. 102 located above the front cover 64 is associated with personal records received in the neighboring sleeve 12, 102 located above the rear cover 66 and associated with the photographs received in the pockets 60, 86 of the device 14, 104 between such sleeves 12.

Although not shown as such, the album assembly 10, 100 includes, as mentioned, seventeen sleeves 12, 102 and sixteen devices 14, 104 interleaved between the sheets 12, 102. It is, however, to be appreciated that additional sleeves 12, 102 and/or additional devices 14, 104 may be added to the assembly 10, 100, or their number may, if desired, be reduced. As will be appreciated, the assembly 10, 100 may include both the sheets 12 and 102 and both the devices 14 and 104. In the illustrated examples, the album has a size slightly exceeding A3, but can naturally be of other sizes, as desired.

It is expected that an album assembly in accordance with this invention will particularly advantageously be applicable for keeping personal records of scholars or pre-schoolers. Each sleeve 12, 102 and its associated device 14, 104 may thus, for example, receive personal records pertaining to a particular school year or to a particular pre-school year.

1. A file assembly for keeping personal records, the assembly, including in combination:
a plurality of sleeves, each sleeve having opposed operatively front and rear walls, the front wall being smaller than the rear wall, and the front wall having a periphery along part of which it is secured to the rear wall, such that the walls define between them a pocket, having a peripheral opening, for receipt of personal records;
a plurality of photograph display devices for displaying at least one photograph each; and
a binder within which the sleeves and the photograph display devices are received, the binder having a securing mechanism for releasably securing each sleeve and each photograph display device in place therein.

2. An assembly as claimed in claim 1, in which the binder includes a planar rectangular front cover, a planar rectangular rear cover, and a spine interconnecting the front cover and the rear cover and about which spine the binder is foldable book-fashion, the securing mechanism being located between the covers of the binder, each sleeve, and each photograph display device being secured between the covers of the binder.

3. An assembly as claimed in claim 2, in which the front cover, the rear cover and the spine of the binder are of board-like construction, the spine being rectangular and adjacent edges of the spine and of each of the covers defining a pair of fold lines about which the binder is foldable.

4. An assembly as claimed in claim 3, in which the front cover, the rear cover and the spine of the binder are integrally formed, the binder being provided with two laterally spaced substantially parallel grooves extending over at least one face of the binder and defining the spine therebetween, the grooves providing said fold lines about which the binder is foldable.

5. An assembly as claimed in claim 2, in which the securing mechanism comprises a row of clasps fast with the rear cover adjacent the spine or fast with the spine and spaced in series from each or one another, each sleeve and each photograph display device being provided with a corresponding plurality of openings adjacent edges thereof extending alongside the spine, through which openings the clasps are received.

6. An assembly as claimed claim 5, in which each sleeve is rectangular in outline, the front wall of the sleeve being spaced outwardly from the edge of the rear wall extending alongside the spine, the openings through the sleeve extending only through the rear wall of the sleeve, and areas of the rear wall surrounding said openings being reinforced to inhibit initiation or propagation of cracks or tears in the rear wall.

7. An assembly as claimed in claim 1, in which each sleeve is of unitary construction, being formed from a single sheet of cardboard which is folded over on to itself to define the front wall and the rear wall, side edges of the front wall being folded towards each other to define flaps by means of which the side edges of the front wall are secured to the rear wall.

8. An assembly as claimed in claim 1 in which each photograph display device includes at least one rectangular transparent photograph-receiving pocket for receiving photographs or for receiving a sheet on which photographs are mounted.

9. An assembly as claimed in claim 1 in which each photograph display device and the rear wall of each sleeve are essentially the same shape and size when seen face-on, each photograph display device and the rear wall of each sleeve being smaller in outline than the front cover and the rear cover of the binder, such that the front and the rear covers of the binder at free edges thereof overhang each sleeve and overhang each photograph display device received therebetween.

10. An assembly as claimed in claim 1, in which the photograph display devices are interleaved between the sleeves to alternate therewith, an operatively rear face of the rear wall of each sleeve providing writing space for receiving written information associated with records kept in the pocket of the sleeve.

11. An assembly as claimed in claim 1, it which includes a protective cover within which the binder is received for protecting it, the cover being in the form of a box-shaped sheath.
